(19) United States
(12) Patent Application Publication
(10) Pub. No.: US 2023/0415121 A1
(43) Pub. Date: Dec. 28, 2023

(54) MIXED METAL OXIDE-HYDROXIDE BIOPOLYMER COMPOSITE BEADS AND A PROCESS THEREOF

(71) Applicant: COUNCIL OF SCIENTIFIC AND INDUSTRIAL RESEARCH (AN INDIAN REGISTERED BODY INCORPORATED UNDER THE REGN, New Delhi, Delhi (IN)

(72) Inventors: Sujana MARYGUDE, Odisha Bhubaneswar (IN); Sathish RAMALINGAM, Odisha Bhubaneswar (IN); Boopathy RAMASAMY, Odisha Bhubaneswar (IN); Abhaya KUMAR SAHOO, Odisha Bhubaneswar (IN); Biswaranjan DAS, Odisha Bhubaneswar (IN); Priyankarani BEHERA, Odisha Bhubaneswar (IN); Debabrata SINGH, Odisha Bhubaneswar (IN); Suddhasatwa BASU, Odisha Bhubaneswar (IN)

(21) Appl. No.: 18/247,382

(22) PCT Filed: Aug. 4, 2022
(86) PCT No.: PCT/IN2022/050700

§ 371 Date: Mar. 30, 2023

(30) Foreign Application Priority Data
Aug. 17, 2021 (IN) 202111037374

(51) Int. Cl. B01J 20/08; B01J 20/28; B01J 20/30; C02F 1/28

(52) U.S. Cl. CPC B01J 20/08; B01J 20/28026; B01J 20/28019; B01J 20/28059; B01J 20/28061; B01J 20/28071; B01J 20/28083; B01J 20/3085; B01J 20/3071; B01J 20/3042; C02F 1/288; C02F 1/286; C02F 1/281; C02F 2101/14

(57) ABSTRACT

The present invention provides mixed metal oxide-hydroxide biopolymer composite beads for fluoride removal from groundwater and a process for the preparation thereof. The beads developed in the instant invention relate to novel granular adsorption medium which comprises two or more metal oxide-hydroxide/hydroxide/oxide nanoparticles and calcium alginate as supporting medium. The said mixed metal oxide-hydroxides and biopolymer composite (MBC) beads are useful for the treatment of fluoride containing drinking water by both batch and continuous mode operations. The MBC beads also showed arsenic sorption performance from spiked water by batch mode.

### FIELD OF THE INVENTION

The present invention relates to a mixed metal oxyhydroxide biopolymer composite beads and a process for the preparation thereof. The mixed metal oxyhydroxide biopolymer composite beads/granules are useful for de-fluoridation of contaminated groundwater. More particularly, the present invention relates to the development of a porous, easily separable, hydraulically conductive adsorption media with high adsorption capacity for fluoride in the pH range of 4.0-8.5 at ambient temperatures. Additionally, the developed media is also capable of removing other contaminants like arsenic from water. The present invention further pertains to the field of drinking water purification systems, and particularly relates to preparation of mixed metal oxyhydroxide-biopolymer composite beads containing granular adsorption media at ambient temperatures by simple method of preparation. The present invention also provides a novel adsorption media which is stable in aqueous medium and is useful for fluoride removal from contaminated groundwater. The alginate biopolymer is used as supporting matrix to develop stable, porous and hydraulically conductive granular beads, which can be used in columns or in filters cartridges in water purification systems for contaminants removal from groundwater.

### BACKGROUND AND DESCRIPTION OF THE PRIOR ART

Worldwide over 200 million people drink naturally fluoride containing ground water due to lack of affordable purification portions. In India, 20 of 29 states have some degree of groundwater fluoride contamination, impacting 85-97% of districts in some states. Among the affected states, Rajasthan, Andhra Pradesh, Tamil Nadu, Uttar Pradesh and Gujarat are most endemic. In Rajasthan, all 32 districts have been declared as fluorosis prone areas. Therefore, the World Health Organisation (WHO) has recommended acceptable limit of 1.0 mg/L and the maximum tolerance limit in the absence of alternate source is 1.5 mg L⁻¹ in drinking water for fluoride. The fluorosis problem is a matter of serious concern in many countries around the globe and sustainable technologies are need of the hour.

Over the last few decades, extensive studies were reported for fluoride removal from drinking water. Most widely used technological options are adsorption, chemical coagulation/precipitation, ion-exchange and membrane based separation technique, etc. Wide variations are observed in applicability and viability of the reported techniques in affected areas due to socio-economic conditions which vary from country to country, and treatment options are not equally available in all the affected countries. Among these technologies, activated alumina based adsorption systems are well accepted and widely used for fluoride removal from water by many countries.

The metal oxide surfaces generally have positive surface charges in most geological environment, and therefore, selectively adsorb anions. At the bench scale, various number of nano sorbents have been tested for removal of fluoride from water and wastewaters. Though these nano-sorbent combines the advantages of high affinity with fast kinetics, the preparation cost and nano particle separation from drinking water is another difficult task.

Several efforts were made to develop granular adsorption media by spray coating of Fe—Al—Ce oxides on sand surface, Fe—Al—Ce hydroxide nano-adsorbent by immobilization in porous polyvinyl alcohol, polystyrene encapsulated zirconium phosphate nanocomposite. Similarly, granular Zr—Fe oxides and granular ferric oxide are reported at bench scale. The biomaterials offer a relatively inert aqueous environment within the matrix, and high gel porosity allows high diffusion rates of macromolecules. Mesoporous Al₂O₃, La, Ce, Mg, Zr oxide/hydroxides doped/incorporated chitosan, chitin, cellulose and alginate composites were synthesized and tested for their de-fluoridation efficiencies from water and waste waters. La-chitosan beads for de-fluoridation studies and reported that the studies enhanced the fluoride removal efficiency by 7 times as compared to activated alumina. However, leaching of La ions into the treated water was reported by the researchers. Similar efforts were also made using alginate, chitin and chitosan systems by wet impregnation method for Fe, Mg, Zr and La metal oxides (Sujana et al., 2013; M. Sarkar and D. Santra 2015).

U.S. Pat. No. 6,203,709 B1 relates to preparation and application of ferric iron doped calcium alginate beads by impregnation method and successful application for removal of arsenate and selenite from polluted water. The system is operated as either a batch-type or continuous feed purifier. However, the method comprises the additional step of dehydration for drying of spent absorbent beads to form a dry disposable solid waste product.

CN102942239A relates to the use of polymer-based composite material comprising styrene-divinylbenzene copolymer microspheres and hydrated nano particles of zirconium oxide for fluoride removal from both drinking water and industrial wastewater. However, the drawbacks associated with the said prior art include the use of toxic and costly chemicals, stability of the polymer coating and maintenance by skilled persons makes the technology expensive. In the present invention, no harmful or costly chemicals were used. Biodegradable matrix like sodium alginate water has been used for uniform bead preparation.

CN 102580665B discloses a method of preparation and application of nano-particle composite consists of FeCl₃·6H₂O and FeCl₂·4H₂O in hydrochloric acid solution, along with lauryl sodium sulfate solution and Al₂(SO₄)₃·18H₂O. The nano particle composites prepared under controlled temperatures (70-90° C.), showed maximum fluoride adsorption capacity of 63.8 mg/g, fast kinetics and wide working pH range. However, lauryl sodium sulfate is a detergent and surfactant, that may have health related issues for potable water.

JP 2006000818A discloses a process based on adsorbing medium containing metal hydrous oxide of Zr, Ti, and rare earth elements containing ion exchanger and porous polymer film. Adsorbent is effective at pH-4 and is capable of removing traces of fluoride, arsenate and arsenite ions in water. However, the drawbacks associated with the said prior art include use of costly materials and limited efficiency in neutral pH range. In the present invention, inorganic precursors and biopolymer have been used.

US2013168320 (A1) discloses granular composites comprising a biopolymer and one or more metal-oxyhydroxide/hydroxide/oxide nanoparticles. The biopolymer comprises chitosan, banana silk, cellulose, or a combination. The metal precursors consist of Al, Zr, Fe, La, Ce, Mn, Ti, or in combinations. The granular composite has an arsenic adsorption capacity in excess of 19 mg/g at an initial arsenate concentration of 0.1 to 1 mg/L; whereas fluoride adsorption capacity of 53 mg/g at neutral pH. However, in the said prior art, working pH range and safe disposal of exhausted material was not discussed. The wide variation in adsorbent particle size 0.1 to 3 mm may decrease hydraulic conductivity while working in packed bed systems thereby require special devices which makes the solid-liquid separation recycling expensive. The adsorbent beads and process developed in the present invention is completely different with this invention. In the present invention, mixed metal oxyhydroxide biopolymer composite beads have been prepared in 0.8-2 mm size with good hydraulic conductivity, and a working pH range of 4.5 to 7.5 for fluoride removal.

WO 2012/077033 A2 discloses the organic-inorganic composite material for removal of anionic pollutants, especially, high sorption efficiency for fluoride and arsenic from water. The material comprises of chitin or other low cost biogenic materials (4-15%) viz., chitosan, leaf, onion or banana peel, citrus fruits waste as carbon source and Al and Fe salts were selected as inorganic source (55-75%). The organic-inorganic composite material was obtained by calcination of dried metal salt and biomaterial suspension mix at 450-500° C., followed by washing and drying. The material showed arsenic and fluoride removal efficiency in the range of 70-99.73%. However, for practical application in water treatment systems, nanoparticle or fine powdered adsorbents cannot be used directly because of their low hydraulic conductivity (high-pressure drop) in packed bed systems. The beads developed in the present invention show good hydraulic conductivity and can be used in packed bed systems. The adsorbent and process in this invention is completely different.

Though significant work has been carried out and even reported as possible solution for fluoride mitigation by using different adsorbents, the problem is persisting because of reasons stated herein below:
a) High cost-technology, i.e., either the price and/or the technology is high, demanding expensive chemicals, skilled operation or regeneration, separate devices are needed for nano sorbents etc.
b) Limited efficiency, i.e., the method does not permit sufficient removal of the fluoride, even when appropriate dosage is used.
c) Equilibrium time and working pH range of the sorption media.
d) Deteriorated water quality, i.e., the water quality may also deteriorate due to prepared medium or due to medium escaping from the treatment container.

Activated alumina (AA) adsorption system for fluoride and arsenic is one of the effective and widely used for drinking water treatment. However, this technology too has certain limitations such as low adsorption capacity, and limited working pH range. The current problem with the alumina is leaching, because of low fluoride adsorption capacity. AA requires frequent regenerations and requires replacement after two or three regenerations. Similarly, enough care should be taken for quality of treated water, especially where frequent regeneration of adsorbent is required.

For practical application in water treatment systems, nano particle or fine powders cannot be used directly because of their low hydraulic conductivity (high pressure drop) in packed bed systems. Nano-sorbents would have to be used in special devices, which makes the solid-liquid separation and recycling difficult and expensive.

From the aforesaid, it can be observed that there are significant numbers of prior art documents available on use of iron salt and aluminium salt with sodium alginate as adsorbent for defluoridation of water. However, no reports are there on use of composite materials comprising Fe—Al, Fe—Al-lanthanum/zirconium/cerium/magnesium/manganese/salts along with sodium alginate as supporting matrix for preparation of stable bead structures, so as to result in adsorption media for defluoridation of potable water.

Thus, keeping in view the drawbacks of the hitherto reported prior art, there exists a dire need to provide a biopolymer supported mixed metal oxyhydroxide beads or granules for defluoridation of fluoride containing drinking water as well as a process for the preparation thereof, wherein the composite beads are porous, easily separable, hydraulically conductive adsorption media for treatment of fluoride containing ground water, which is also capable of removing other contaminants like arsenic from water, and wherein the developed adsorption media is capable of working in batch and in continuous mode operations at pH conditions of 4.0 to 8.0, and is stable in the aqueous environment.

### Objectives of the Invention

The main objective of the present invention is to provide a novel adsorption media which can be used for defluoridation of contaminated groundwater, and also for the removal of other contaminant, like arsenic removal, from water.

Another objective of the present invention is to provide a process for the preparation of easily separable, hydraulically conductive and stable adsorption media which can be used directly in columns or in cartridges to provide safe drinking water.

Yet another objective of the invention is to provide process for the synthesis of granules/beads composed of iron and aluminium metal oxyhydroxides and a biopolymer as supporting medium for water purification systems having ability to confiscate anionic contaminant like fluoride, and arsenic ions from the ground water.

Still another objective is to provide mixed metal oxyhydroxides biopolymer composite beads for treatment of real life fluoride containing groundwater, and also for treatment of arsenate spiked water at neutral pH.

Yet another objective of the present invention is to develop a process using simple inorganic precursor salts for preparation of binary mixed metal oxyhydroxides comprising Fe and Al at temperatures 27° C. (±5) in all possible combinations between 6:1 to 1:6 and/or in specific range between 2:1 to 1:6 in weight/molar ratios.

Further objective of the present invention is to develop a process for preparation of ternary mixed metal oxyhydroxides comprising Fe, Al in combination with any of Ce, Zr, La, Mn, Mg and Cu metal oxyhydroxides at 27° C. (±5) temperatures in all possible combinations weight ratio combinations 1:1-6:0.1-0.7 wt %.

Yet another objective of the present invention is to study characterization of the developed granules/beads by XRD, FTIR, FESEM, TEM, XPS and BET adsorption and desorption isotherm studies, and pHP_{PZC}.

Still another object of the present invention is to provide optimum process parameters for removal of fluoride and arsenic from water by performing batch adsorption tests, viz., initial fluoride concentration variation, adsorbent dose variation, and pH variation.

Another objective of the present invention is to develop a process for the preparation of stable metal oxyhydroxides-biopolymer composite beads/granules in the size ranging between 0.8 to 2.0 mm.

Still another objective of the present invention is to provide performance evaluation of developed beads for fluoride removal from by continuous column mode operations.

Yet another additional aspect of the invention is to provide process for regeneration of the fluoride and arsenic loaded beads by following simple procedures for reuse.

Still another objective of the present invention is to provide data for Toxicity Characteristics Leaching Procedure (TCLP) test for the fluoride exhausted MBC beads that may be acceptable for safe disposal as a non-hazardous material thereof.

### SUMMARY OF THE INVENTION

As mentioned above, the present invention relates to preparation of granular stable bead structures comprising binary/ternary mixed metal oxides/oxyhydroxides and a biopolymer prepared at ambient temperatures (25-35° C.) in an aqueous medium.

Accordingly, the present invention provides a composition and a method for preparation of mixed metal oxyhydroxide biopolymer composite (MBC) beads comprising of 15-55% metal content (iron, aluminium and/or other metal), 15-35% biopolymer, and the remaining being oxygen and hydrogen.

In an embodiment of the present invention, there is provided a mixed metal oxyhydroxide biopolymer composite beads for fluoride removal from drinking water wherein, the said beads comprising: 15 to 55 (w/w) % of a metal content; 10 to 35 (w/w) % of a biopolymer; remaining being oxygen and hydrogen, wherein the mixed metal content comprises Fe and Al in the range of 6:1 to 1:6, preferably 1:1 to 1:6.

In an embodiment of the present invention, the biopolymer supported mixed metal oxyhydroxides beads contain Fe:Al molar/weight ratios in 6:1-1:6; and preferably in the range of 1:1 to 1:6, or Al content varying between 10-60% by weight.

In another embodiment of the present invention, by using MBC beads anionic contaminants, such as fluoride, can be selectively removed from drinking water in batch and continuous mode operations.

In yet another embodiment of the present invention, the mixed metal oxyhydroxides biopolymer composite (MBC) beads can comprise Fe:Al in binary mixed metal oxyhydroxides form.

In yet another embodiment of the present invention, the metal are selected from the group consisting of Fe, Al, Cu, Mn, La, Zr, Ce, and Mg.

Yet in another aspect, the MBC beads can also comprise ternary mixed metal oxyhydroxides of Fe:Al:Z, wherein Z can be selected from copper/manganese/lanthanum/zirconium/cerium/magnesium, and the weight ratio of third metal (Z═Cu, Mn, Mg, La, Zr and Ce) content can be 0.1-10 wt % to total metal content of Fe and Al in the beads.

Yet in another aspect, the MBC beads can also comprise ternary mixed metal oxyhydroxides of Fe:Al:Z, wherein Z can be selected from copper/manganese/lanthanum/zirconium/cerium/magnesium, and the weight ratio Fe:Al:Z is in the range of 1:1 to 6:0.1 to 0.7.

In yet another embodiment of the present invention, the biopolymer is sodium alginate.

In yet another embodiment of the present invention, aluminium metal precursor salt or solution are selected from the group consisting of nitrate/sulphate/chloride/isopropoxide/alum salts, or a combination thereof.

In still another embodiment of the present invention, the iron precursor solutions are prepared by using sulphate/chloride/nitrate salts of iron as such or in combinations.

In yet another embodiment of the invention, nitrate/sulfate/chloride precursor salt solutions of Cu, Mn, Mg, La, Zr and Ce are used for the ternary mixed metal oxyhydroxides.

In still another embodiment, the beads exhibit the characteristic properties—Surface areas: 40 to 100 m2/g; Pore Volume: 0.25 to 0.45 cm3/g; and Pore size: 100 to 180 Å. Further, the beads exhibit fluoride and arsenic removal efficiencies to the extent of >90% from contaminated groundwater at pH range of 5 to 8, and at temperature ranging from 10 to 35 degree. In yet another embodiment, the beads show fluoride adsorption capacities of 5 to 20 mg/g, and arsenic adsorption capacities of 500 to 1000 μg/g, and 100 to 200 μg/g for arsenate and arsenite, respectively.

In still another embodiment of the present invention, the required metal precursors can be taken directly in the salt form into the distilled water or molar solutions in distilled water.

In yet another embodiment of the present invention, the metal precursors used for binary metal oxyhydroxides can be any combinations of Fe:Al in desired ratios between 2:1-1:6.

In still another embodiment of the present invention, the binary/ternary oxyhydroxides/hydroxides are prepared in two steps following co-precipitation and/or deposition precipitation techniques.

In yet another embodiment of the present invention, metal salts precipitation reactions are carried out at room temperatures of 20-34° C., and no elevation of temperatures or pressures are needed during metal oxyhydroxide preparation or beads preparation.

In still another embodiment of the present invention, the precipitation reactions can also be performed at <20° C., or above temperature of >32° C. i.e., 32 to 100° C.

In yet another embodiment of the present invention, no purging of gas (nitrogen) was required during mixed metal oxyhydroxides biopolymer composite beads preparation.

In still another embodiment of the present invention, the MBC beads could also be prepared under purging of nitrogen.

In yet embodiment of the present invention, iron oxide is co-precipitated at pH 9.0-9.5.

In still another embodiment of the present invention, the mixed metal oxyhydroxides precipitation reactions are performed at a pH of 6.5-8.0.

In yet another embodiment of the present invention, the resulting mixed metal oxyhydroxides particles size ranges between 100 to 200 mn, and the mixed metal oxyhydroxides/oxides particle size can vary from 5 nm to 200 nm.

In still another embodiment of the present invention, the biopolymer solution is prepared by taking alginic acid sodium salt in the range between 1-5% w/v in distilled water/deionized water/pure water/water.

In a further embodiment of the present invention, for bead preparation mixed metal oxyhydroxide nanoparticles dispersed in aqueous solution are mixed with biopolymer solution under vigorous stirring rate ranging from 500-1000 rpm, or more required stirring speed depending upon the volume of the contents to obtain homogeneous mixture, at ambient temperatures between 20-32° C.

In still another embodiment of the present invention, the biopolymer solution can also be prepared by elevating temperatures i.e., >32° C. or lower temperatures i.e., <20° C.

In yet another embodiment of the present invention, size selective MBC spherical gel beads are synthesized (1-2 mm size range in diameter) by dripping technique, using the peristaltic pump. The bead size can be varied and selective by choosing appropriate peristaltic pump tubing size.

In another embodiment of the present invention, the strength of the gelation solution CaCl₂) is chosen between 1 to 5% w/v, and the curing time of the beads in gelation bath is chosen between 1 to 24 h. The gel beads are then rinsed with distilled water/pure water.

In still another embodiment of the present invention, the MBC beads are protonated with 0.05-0.2 N acidic solution containing either any one or combinations of HCl/HNO₃/H₂SO₄/CH₃COOH for time period taken between 1 to 48 h.

In yet another embodiment of the present invention, the developed MBC beads are rinsed thoroughly with distilled water/water until washed water shows pH ≥6.

In still another embodiment of the present invention, the drying of the beads can be done under fan at ambient temperatures or under sun light or in a hot air oven at 70° C. until they are completely dried.

In yet another embodiment of the invention, based on the preliminary feasibility considerations of the batch adsorption data, one of the best system was taken for ternary mixed metal oxide/oxyhydroxides/hydroxides preparation Fe:Al:Z; where Z is one of the metal from Ce, La, Cu, Mg, Mn and Zr.

In still another embodiment of the present invention, the ternary mixed metal oxyhydroxides containing biopolymer beads of Fe:Al:Ce; Fe:Al:Zr; Fe:Al:La; Fe:Al:Mg; Fe:Al:Cu; and Fe:Al:Mn are prepared by following the same method of preparation by taking three metal precursors solutions in desired amounts.

In yet another embodiment of the present invention, Z (Ce, La, Cu, La, Mg, Mn) elemental weight ranges from 0.1-10 wt % of Fe:Al system.

In still another embodiment of the present invention, a simple method of preparation is provided which is devoid of high temperatures or pressure and purging of nitrogen gas. The biopolymer used is abundantly available in the nature, thereby, making the MBC bead preparation easy and economical.

In yet another embodiment of the present invention, the MBC beads have been characterized by pH_{PZC}, XRD, FESEM, TEM, XPS, BET surface area, and FTIR.

In another embodiment of the present invention, the prepared beads showed BET surface areas ranging between 70-101 m²/g for the best samples.

In still another embodiment, the present invention further provides a process for removal of anionic contaminants such as fluoride and arsenic by batch adsorption tests. Different adsorption parameters such as effect of contact time variation; initial anion concentration variation; MBC bead dose variation; pH variation tests were conducted.

In yet another embodiment of the present invention, batch tests contents were taken in polypropylene bottles and agitated in a temperature controlled water bath shaker at ambient temperature for a prescribed period time. The remaining anion (fluoride and arsenic) concentrations in the water were analyzed by following standard methods.

In still another embodiment of the present invention, performance of MBC beads were tested with real life fluoride containing groundwater collected from fluoride endemic region. The result of MBC beads were compared with commercial Activated Alumina granules in batch and column mode adsorption.

In yet another embodiment of the present invention, the prepared MBC beads also showed advantages, such as of dropping alkalinity and total hardness levels along with fluoride in the groundwater.

In still another embodiment of the present invention, the MBC beads were also tested for fluoride removal by MBC beads in continuous mode operations, by pumping fluoride containing groundwater in an up flow mode with residence time 0.32 h. A fairly sharp breakthrough curve was observed with column packed with approximately 12.9 g of beads, with influent fluoride concentration of 2.9-3.0 ppm at pH 7.46. The breakthrough point, i.e., fluoride concentration in the treated water reached 1.5 mg/L after 288 h with treated water capacity of approximately 20.7 L.

In yet another embodiment of the present invention, the exhausted MBC beads with anionic contaminants can be reused after regeneration at an ambient temperature.

In yet another embodiment of the present invention, the regeneration media can be selected from 0.01-0.05 acetic acid and/or 0.0005-0.001M NaOH and treatment period between 4-48 h.

In still another embodiment of the present invention, the advantages associated with safe disposal of the exhausted medium, the column exhausted fluoride loaded beads was tested for Toxicity Characteristic Leaching Procedure (TCLP) test. Studies were conducted according to the standard operating procedure (SOP-8131) based on Environmental Protection Agency (EPA) Methods SW846/1311. The TCLP test results were observed that the broken beads leached fluoride levels <5 mg/L which is much below the acceptance of hazardous wastes for direct disposal guidelines by US, EPA and CPCB, India.

In a further embodiment of the present invention, the mixed metal oxyhydroxide biopolymer composite beads comprise: 5 to 20% Iron; 15 to 40% Aluminium; 5 to 15% Carbon; 35 to 55% Oxygen; 0.5 to 3.0% Calcium; 1 to 5% Sulphur; and 4 to 10% Hydrogen.

### BRIEF DESCRIPTION OF THE ACCOMPANYING DRAWINGS

The following figures provide a further explanation and better understanding of the invention as claimed. The invention may be better understood by references to one or more of these figures in combination with the description of specific embodiments presented herein.

FIG. 1. Represents a schematic representation of process steps in preparation of Mixed metal oxyhydroxide Biopolymer Composite (MBC) beads.

FIG. 2A. Represents the SEM images of Mixed metal oxyhydroxides Biopolymer (MBC) beads prepared by the method of the present invention.

FIG. 2B. Represents the morphology of the bead surface at higher magnification.

FIG. 3. Represents the X-ray Photoelectron Spectroscopy (XPS) survey spectra of MBC beads before and after fluoride adsorption. The presence of adsorbed fluoride is confirmed by a new F is peak at 683.5 eV, along with other key elements on MBC beads surface.

### DETAILED DESCRIPTION OF THE INVENTION

The terminology used to express herein for describing the methodology is for particular aspects only and is not intended to be limiting. Although any metal salts, methods and materials similar to those described here can be used for the materials preparation. Considering the ease of method of preparation simple operational steps were followed, if there of number of additional steps that can be included with any specific embodiment or with combination of embodiments of the methods of the invention.

The terms “metal oxyhydroxide” and “metal oxide hydroxide” shall be used interchangeably.

For the preparation of a novel adsorption medium for fluoride removal from water, at first a series of mixed metal oxyhydroxide biopolymer composite beads samples were prepared by coprecipitation and/or deposition precipitation method. For iron source, precursor salt was taken from anhydrous FeCl₃/Fe(NO₃)₃·9H₂O/FeSO₄·7H₂O any one or in combinations thereof. For aluminium source any salt from Al(NO₃)₃·9H₂O/Al₂SO₄·16H₂O/AlCl₃ either alone or in combinations was taken. The La, Mg, Mn, Cu, Ce and Zr precursors taken were from any of nitrate/sulfate/chloride salts of these elements. The precipitant used was any one or combinations of NH₃/NAOH/KOH and the pH requisite values are in-between 6.5-9.5 for mixed metal oxyhydroxides synthesis. Alginic acid sodium salt was used as biopolymer support here. All the experiments were performed at ambient temperatures.

### Methodology Adopted for Development of the Product/Process

### A. Preparation of Binary Mixed Metal Oxyhydroxide Biopolymer Composite Beads

A series of binary Al—Fe oxyhydroxide/oxides/hydroxide systems were synthesized in any selected elemental mass/molar ratios ranging between 6:1 to 1:6 by following simple co-precipitation/deposition precipitation/precipitation method at temperature below 32° C.

Adsorbent beads containing Fe:Al (2:1) mixed metal oxyhydroxide biopolymer composite beads were synthesized in 2 steps the details of which are given below.

Step 1
a) Preparation of iron oxide nanoparticles was done by precipitation/co-precipitation technique at pH 9.2-9.5 by taking 3.24 g of iron(III) chloride anhydrous and 2.78 g of iron(II) sulfate heptahydrate salt in 200 mL distilled water at 27° C. (±5) temperature by using sodium hydroxide as precipitant. Further, the precipitates were stirred for 30-60 minutes and washed free of unwanted impurities with lukewarm/normal distilled water for 4-5 times.
b) Dispersion of nanoparticles in the 200 mL distilled water and addition of 9.78 g aluminium sulfate hexadecahydrate precursor salt to it under vigorous stirring. The pH was raised to 7.5-8.0 value by slow addition of potassium hydroxide solution under stirring. Obtained mixed metal oxyhydroxide particles were further stirred for 30-60 minutes and then washed with distilled water by taking them in centrifuge bottles for 5-6 times until free from unwanted ions and pH of neutral. The metal nanoparticles were dispersed in 25-30 mL of distilled water.

Step 2
(a) Biopolymer solution was prepared by taking 2.5 g alginic acid sodium salt in 100 mL distilled water within the range of 1.5-2% w/v ratios under vigorous stirring until it is thoroughly mixed.
(b) Mixed metal oxyhydroxides nanoparticles prepared in the step 1 were added to this solution slowly under vigorous stirring and continued till the homogeneous mix is formed. The sodium alginate content to mixed metal oxyhydroxide was maintained between 1:2-1:2.5 w/w ratio.
(c) Mixed metal oxyhydroxides-Biopolymer Composite homogenous mixture was introduced drop wise into gelation bath containing requisite CaCl₂) solution having strength in the range of 1.5-2% w/v through a thin nozzle with ID 0.6-1.0 mm connected to a peristaltic pump tubing with a flow rate of 10-15 mL min⁻¹. The gel beads curation time was chosen between 4-24 h in the same solution for.
(d) The gel beads were rinsed with distilled water thoroughly 3-4 times and protonated with solution containing HCl/HNO₃/H₂SO₄/CH₃COOH any one or in combinations for period range of 4-48 h. The beads were then rinsed with distilled water and dried at room temperatures and/or under sun light until they are completely dried and then stored in an airtight container for further use. Binary metal oxide systems of Fe:Al in different weight ratios between of 2:1, 1:1, 1:2, 1:4 and 1:6 were synthesized.
(e) Preliminary batch adsorption studies were conducted by taking binary metal oxide/hydroxides adsorbent materials for fluoride removal under similar conditions and results of the best materials are given in the Table-1.

### B. Preparation of Ternary Mixed Metal Oxyhydroxides Biopolymer Composite Beads

Ternary mixed metal oxyhydroxide systems were prepared by taking one of the best optimized combinations of Fe:Al along with one of the metal precursor salt selected from the group consisting of Ce, La, Zr, Cu, Mg, Mn (nitrate/chloride/sulfate salts). Ternary mixed metal oxyhydroxides containing biopolymer beads of Fe:Al:Ce; Fe:Al:Zr; Fe:Al:La; Fe:Al:Mg; Fe:Al:Cu; and Fe:Al:Mn were prepared by following the same method of preparation by taking metal precursors solutions in desired amounts along with aluminium precursor salt solution in step-2, (b). The metal content Z (Ce, La, Cu, La, Mg, Mn) to Fe:Al system can by any one value between 1-10 wt %. The details of the process for preparation of Fe:Al:Ce (1:2:0.3) mixed metal oxyhydroxide containing biopolymer beads are as follows:

Step 1
(a) Same as described in step-1 of A.
(b) The nanoparticles obtained from step-1 of A was dispersed in required 200 mL volume of distilled water and to this 39.5 g of aluminium precursor salt along with requisite 1.55 g of cerium(III) nitrate hexahydrate precursor salt was added under stirring. The mixture was vigorously stirred for 30-60 minutes, and the solution pH was slowly raised to 8.0 by using alkali. The contents were stirred further for 30-60 minutes and then washed with distilled water by taking them in centrifuge bottles for 4-5 times. The prepared mixed metal oxyhydroxide nanoparticles are dispersed in 100 mL distilled water.

Step 2
(a) Biopolymer solution was prepared by mixing 5.56 g of sodium alginate in 180 mL of distilled water under mechanical stirring
(b) Bead preparation is same as explained in step 2 of A.

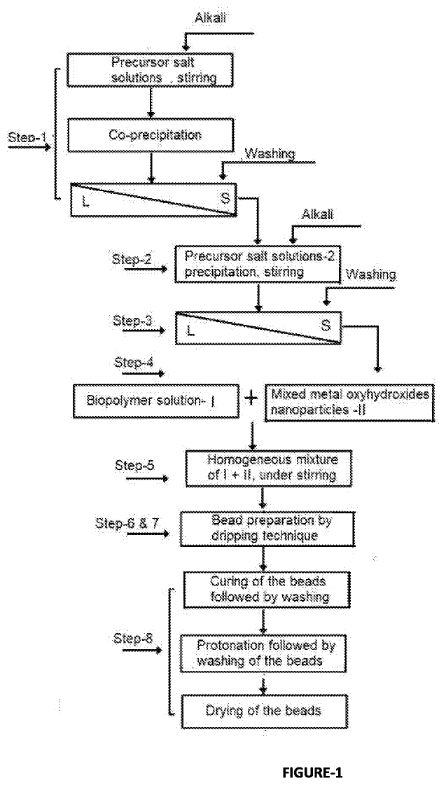

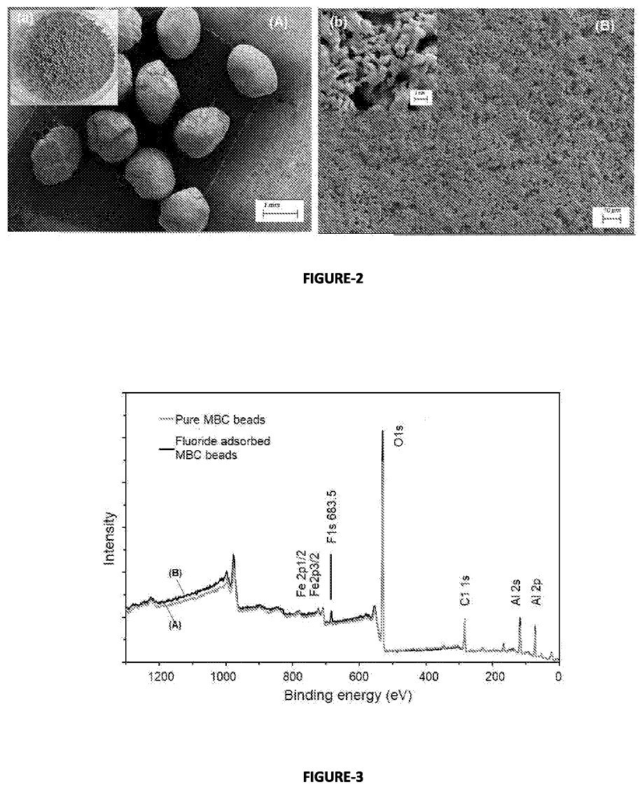

A schematic diagram for process of preparation of MBC beads is given in FIG. 1.

### C. Conditions and Apparatus for Batch Sorption Experiments:

The batch adsorption experiments were conducted by taking known amount of adsorbent sample in a 125 mL polyethylene plastic vial along with 50/100 mL of fluoride/arsenic solution of known concentrations. The pH of the solutions were adjusted by using 0.1N HCl and 0.1N NaOH solutions and the contents were kept for agitation in a temperature controlled water bath shaker for required time and then the solids were separated and fluoride concentration in the solutions was determined. The adsorption capacity g_{c} (mg g⁻¹) of the adsorbent was calculated from the equation q_{c}=[(Cᵢ−C_{f})*V]/W where C_{f} the equilibrium concentration (mg/L), Cᵢ is initial adsorbate concentration (mg/L), V is volume of the solution (L) and W is the weight of adsorbent (g). Batch adsorption experiments were carried out in triplicate and the average values are reported. ORION Ion Selective Electrode and combination pH electrodes were used for fluoride and pH measurements. Arsenic analysis in the water samples was carried out on Metrohm 884 Professional VA instrument using scTRACE Gold sensor (US EPA SW-846 Test Method 7063 by Anodic Stripping Voltammetry (ASV)). Acid digested mixed metal oxyhydroxide biopolymer composite bead samples were subjected for chemical analysis by ICP-OES, icap7600, (Thermo Fisher Scientific), ORION AquaMate 8000 UV-Vis spectrophotometer and UNICUBE, Elementar CHNS Elemental analyzer was used for analysis of C, H, N, and S content in the beads. Standard Reference Materials were used for all chemical analysis. TYPE I water was used for all standards preparation, fluoride and arsenic stock solutions preparation and calibrations.

### D. Characterization of the Materials

The The X-Ray Diffraction (XRD) patterns of mixed metal oxyhydroxide biopolymer composite beads prepared at various different experimental conditions and compositional variations were recorded by using Phillips Powder Diffractometer Model PW3710 with Cu K_ radiation at a scan speed of 1.2 min⁻¹ over a range of 10-80°. The peak position and patterns were analyzed by comparing with X' pert High Score software. For Fe—Al containing binary systems, peaks at 30.26, 35.60, 43.10, 57.20 and 62.72 attributed to crystal planes of iron oxide at (102), (114), (212), (220), (232), and (228) and matched well with reference code: 98-009-2356. Two broad peaks at 18.45 and 20.28 2θ values corresponding to (002) and (110) planes elucidated Gibbsitic A1 (Ref. Code: 00-007-0324). The broadened XRD peaks imply that the crystallite size of the Fe—Al mixed metal oxyhydroxide particles are very small, and the mean crystallite size calculated from the Scherrer formula shows that nanocrystals are of an average size of 26.5 nm.

Fourier Transform Infra-Red (FT-IR) spectra of raw beads and fluoride and arsenic adsorbed beads were taken by using Varian-Australia, model 800 spectrophotometer. The FTIR spectrum of pure MBC beads showed broad intense characteristic bands at 3200-3500 and 1611 cm⁻¹ corresponding to OH stretching and bending vibrations of absorbed water as well as strong asymmetrical stretching vibration bonds in carboxyl groups. Characteristic broad band between 520-650 cm⁻¹ can be attributed to M-O (Fe—O and Al—O) vibrations. As beads are composite material, slight shift in the band positions were noticed when compared to pure Fe and Al systems. A small band at 1420 cm⁻¹ may be due COO asymmetric and symmetric stretching due to biopolymer. The FTIR spectra of fluoride and arsenic adsorbed MBC bead showed significant changes in band intensities of hydroxyl and carboxylic groups, indicating involvement of these functional groups in fluoride or arsenic ions uptake.

The Field Emission Scanning Electron Microscope with EDS (Make CarlZeiss, model: SUPRA GEMINI55) was used to study the surface morphology and element dispersion of the prepared mixed metal oxyhydroxide biopolymer composite beads. The overall shape, and size of developed beads can be seen in FIG. 3A, the adsorbent beads were irregular granules with average size of about 1 mm (±0.2). The high magnification images (3B) confirmed the porous nature of the bead surface. Energy-Dispersive X-ray (EDX or EDS) analysis confirmed the presence of iron, aluminium, carbon and oxygen content in the bead.

Brunauer-Emmett-Teller (BET) adsorption-desorption isotherm study and the BET surface area measurements of the samples were taken on Quantasorb, Quantachrome Corporation, USA. The beads showed characteristic features of Type-IV isotherms with its hysteresis loop indicating the mesoporous surface and multilayer adsorption. The BET surface areas noted for the samples ranged between 40-105 m²/g, pore volume 0.25-0.44 cm3/g; and pore diameter values of 115.97-291.17 Å. The pH_{pzc} of selected sample was determined by solid addition method was found to be 5.2-5.6.

X-Ray Photoelectron Spectroscopic studies were used to investigate the qualitative and quantitative information on the surface elemental analysis and mechanism of the fluoride removal on the MBC bead surface. For this, XPS spectra of raw MBC04 beads was taken before and after fluoride adsorption and is shown FIG. 3. All the characteristic peaks such as Fe 2p, Al 2p, C1s, F1s and O 1s are noted on the surface of the adsorbent. It was also noted that the fluoride adsorption did not affect the binding energies on the peak positions of key elements.

### EXAMPLES

The following examples are given by way of illustration only and therefore should not be construed to limit the scope of the present invention in any manner.

### Example-1

This example describes the synthesis of binary metal oxyhydroxide nanoparticles-biopolymer composite bead structures through a simple wet chemistry route. Iron and aluminium in 1:1 weight ratio was taken for the metal oxyhydroxide nanoparticle composite adsorbent prepared and the sample is denoted as MBC02.

The Method of Preparing Mixed Metal Oxyhydroxide Biopolymer Composite Bead Samples Comprise Following Steps:

Step 1: 16.22 g of iron (III) chloride anhydrous and 13.9 g of ferrous sulfate heptahydrate were weighed and put in a 500 mL capacity beaker containing 200 mL distilled water. The salt contents were mixed thoroughly using a laboratory mixer/magnetic stirrer at 300 rpm. To this solution, 4M NaOH solution was added slowly in a drop-wise manner with vigorous stirring to facilitate the co-precipitation until pH reached 9.2-9.5 at room temperature 27° C. (±5). The precipitate was stirred for 30 minutes more, followed by washing with distilled water 5-6 times to remove unwanted impurities and/or until the pH of the supernatant reaches near neutral.

Step 2: In another 1 L beaker, the precipitate obtained in step-1 was dispersed in 500 mL distilled water and to this 97.9 g of aluminium sulfate hexadecahydrate precursor salt was added under stirring. Contents were stirred for 1 hour and then under a condition of mechanical stirring of 500-700 rpm, 6N potassium hydroxide solution was added dropwise. The pH of the suspension was allowed to rise gradually to 7.5-8 at room temperature 27° C. The precipitates were further stirred for 30 minutes and allowed to settle.

Step 3: The products obtained in Step-2, were transferred into 500 ml centrifuge bottles for washing at 2000-3000 rpm for 5 min. The supernatant solution was decanted and the precipitates were taken in distilled water, mixed thoroughly with glass rod before every wash. This procedure was repeated 4-5 times using distilled water till the pH of the centrifugal supernatant was near neutral. After the process described above was completed, the obtained products were dispersed in 100 mL of distilled water in a 500 mL beaker and labelled as solution A.

Step 4: In a 2000 mL capacity beaker, 16.76 g of sodium alginate was weighed and dissolved in 500 mL distilled water and the contents were stirred vigorously at room temperature 27° C. (±5) for 5-6 h or till a homogeneous mixture without lumps was obtained and labelled as solution-B.

Step 5: The solution-A was transferred into solution-B, and the total volume of the mix was adjusted to 850 mL and/or the strength of the sodium alginate was maintained between 1.8-2% w/v. The sodium alginate to Fe—Al mixed metal oxide hydroxides w/w ratio was maintained in-between 1:2-1:2.5. The contents were stirred vigorously at 800-1000 rpm until a uniform homogeneous mixture is formed. Here the stirring speed and time required to get uniform homogeneous mixture of mixed metal oxyhydroxides and biopolymer composite depends on the contents amount/weight/volume.

Step 6: In a 1 L beaker, 16 g of Calcium Chloride was taken in 900 mL distilled water and stirred until completely dissolved. The strength of the gelation medium was chosen between 1.5-2% w/v and is labelled as Solution-C.

Step 7: Fe—Al mixed metal oxyhydroxide and biopolymer precipitate mixture solution as prepared in Step 5 was added drop-wise into CaCl₂) solution (i.e., Solution-C) using a multi-channel peristaltic pump. Precision pump tubing with an inner diameter of 0.8 mm was used at a flow rate of 10-15 ml/min and dropping was done from a height of 1-1.5 cm above solution-C level. Gel beads in the solution were slowly mixed with a glass rod to avoid the formation of lumps. All these steps were carried out at a temperature of 27° C.

Step 8: The spherical gel beads thus obtained were allowed to cure in gelation medium for 4-24 h. The beads were then rinsed with distilled water 4-5 times and then protonated with 500 mL of acidified (0.05-0.1N HCl/HNO3) distilled water for 4-24 h. The beads were rinsed thoroughly 5-6 times or till the washed water pH is near neutral and then transferred onto trays with blotting paper to remove surface moisture. The beads were dried in a hot air oven at 65-80° C. till they are completely dry or can also be dried under sunlight. The dried MBC beads are stored in an air-tight container for further use.

### Example-2

This example describes the synthesis of iron and aluminium binary mixed metal oxyhydroxide biopolymer composite beads structures having Fe:Al weight ratio of 1:2.5 by simple wet chemistry route and denoted as MBC03. All the steps were carried out at room temperature 27° C.(±5). The method of preparing mixed metal oxyhydroxide biopolymer composite beads comprise following steps:

Step 1: 3.26 g of iron (III) chloride anhydrous and 2.78 g of ferrous sulfate heptahydrate were weighed and put in a 500 mL capacity beaker containing 200 mL distilled water. The salt contents were mixed thoroughly using a laboratory mixer/magnetic stirrer at 200 rpm. To this solution, 4M NaOH solution was added slowly in a drop-wise manner with vigorous stirring to facilitate the co-precipitation until pH reached 9.2-9.5 at room temperature 27° C. (±5). The precipitate was stirred for 30 minutes more, followed by washing with distilled water 5-6 times to remove unwanted impurities.

Step 2: In another 1 L beaker, the precipitate obtained in Step-1 was dispersed in 500 mL distilled water and to this 49 g of aluminium sulfate hexadecahydrate precursor salt was added under stirring. Contents were stirred for 1 hour and then under a condition of mechanical stirring of 500-700 rpm, 6N potassium hydroxide solution was added dropwise. The pH of the suspension was allowed to rise gradually to 7.5-8 at room temperature 27° C. (±5). The precipitates obtained were further stirred for 30 minutes more at that pH and allowed to settle.

The weight ratio of Fe:Al in the metal oxyhydroxide nanoparticle composite adsorbent prepared for fluoride removal was 1:2.5.

Step 3: The products obtained in Step-2, were washed with distilled water by following the same procedure as mentioned in Step 3 of Example-1. After the process described above was completed, the obtained products were dispersed in 500 mL of distilled water in a 1000 mL capacity beaker and labelled as solution A.

Step 4: In a 2000 mL capacity beaker, 5.9 g of sodium alginate was weighed and dissolved in 200 mL distilled water and the contents were stirred vigorously at room temperature 27° C.(±5) for 5-6 h or till a homogeneous mixture without lumps is obtained and labelled as solution-B.

Step 5: The solution-A was transferred into solution-B, and the total volume of the mix was 350 mL and the strength of the sodium alginate was maintained between 1.5-2% w/v. The sodium alginate to Fe—Al mixed metal oxyhydroxides w/w ratio was maintained in-between 1:2-1:2.5. The contents were stirred vigorously at 800-1000 rpm until a uniform homogeneous mixture is formed.

Step 6: In a 1 L beaker, 8.9 g of Calcium Chloride was taken in 500 mL distilled water and stirred until completely dissolved. The strength of the gelation medium was chosen between 1.5-2% w/v and is labelled as Solution-C.

Step 7 and Step 8 are the same as discussed in Example-1.

### Example-3

This example describes the synthesis of iron and aluminium binary mixed metal oxyhydroxide biopolymer composite beads structures having Fe:Al weight ratios of 1:3 by simple wet chemistry route and is denoted as MBC04. All the steps were carried out at room temperature 27° C. (±5).

Step 1: 5.43 g of iron (III) chloride anhydrous and 4.63 g of ferrous sulfate heptahydrate were weighed and put in a 500 mL capacity beaker containing 200 mL distilled water. The salt contents were mixed thoroughly using a laboratory mixer/magnetic stirrer at 200 rpm. To this solution, 4M NaOH solution was added slowly in a drop-wise manner with vigorous stirring to facilitate the co-precipitation until pH reached 9.2-9.5 at room temperature 27° C. (±5). The precipitate was stirred for 30 minutes more, followed by washing with distilled water 5-6 times to remove unwanted impurities.

Step 2: In another 1 L beaker, the precipitate obtained in Step-1 was dispersed in 500 mL distilled water and to this 97.9 g of aluminium sulfate hexadecahydrate precursor salt was added under stirring. Contents were stirred for 1 hour and then under a condition of mechanical stirring of 500-700 rpm, 6N potassium hydroxide solution was added dropwise and the pH of the suspension was allowed to rise gradually to 7.5-8 at room temperature 27° C. (+5). The precipitates obtained were further stirred for 30 minutes more at that pH and allowed to settle. The weight ratio of Fe:Al in the metal oxyhydroxide nanoparticle composite adsorbent prepared for fluoride removal was 1:3.

Step 3: Same as discussed Example-1. The obtained products were dispersed in 500 mL of distilled water in a 1000 mL beaker and labelled as a solution −A.

Step 4: In a 2000 mL capacity beaker, 11.2 g of sodium alginate was weighed and dissolved in 400 mL distilled water and the contents were stirred vigorously at room temperature 27° C. (±5) for 5-6 h or till a homogeneous mixture without lumps is obtained and labelled as solution-B.

Step 5: The solution-A was transferred into solution-B, and the total volume of the mix was 600 mL and the strength of the sodium alginate was maintained between 1.5-2% w/v. The sodium alginate to Fe—Al mixed metal oxyhydroxides w/w ratio was maintained in-between 1:2-1:2.5. The contents were stirred vigorously at 800-1000 rpm until a uniform homogeneous mixture is formed.

Step 6: In a 1 L beaker, 16 g of Calcium Chloride was taken in 900 mL distilled water and stirred until completely dissolved. The strength of the gelation medium was chosen between 1.5-2% w/v and is labelled as Solution-C.

Step 7 and Step 8 are same as discussed in Example-1.

### Example-4

This example describes the synthesis of iron and aluminium binary mixed metal oxyhydroxide biopolymer composite beads structures having Fe:Al weight ratios of 1:4 by simple wet chemistry route and is denoted as MBC05. All the steps were carried out at room temperature 27° C. (±5).

Step 1: 3.26 g of iron (III) chloride anhydrous and 2.78 g of ferrous sulfate heptahydrate were weighed and put in a 500 mL capacity beaker containing 200 mL distilled water. The salt contents were mixed thoroughly using a laboratory mixer/magnetic stirrer at 200 rpm. To this solution, 4M NaOH solution was added slowly in a drop-wise manner with vigorous stirring to facilitate the co-precipitation until pH reached 9.2-9.5 at room temperature 27° C. (±5). The precipitate was stirred for 30 minutes more, followed by washing with distilled water for 5-6 times to remove unwanted impurities.

Step 2: In another 1 L beaker, the precipitate obtained in Step-1 was dispersed in 500 mL distilled water and to this 78.5 g of aluminium sulfate hexadecahydrate precursor salt was added under stirring. Contents were stirred for 1 hour and then under a condition of mechanical stirring of 500-700 rpm, 6N potassium hydroxide solution was added dropwise. The pH of the suspension was allowed to rise gradually to 7.5-8 at room temperature 27° C. (±5). The precipitates obtained were further stirred for 30 minutes more at that pH and allowed to settle.

Step 3: Same as discussed Example-1. The obtained products were dispersed in 500 mL of distilled water in a 1000 mL beaker and labelled as solution −A.

Step 4: In a 2000 mL capacity beaker, 8.4 g of sodium alginate was weighed and dissolved in 350 mL distilled water and the contents were stirred vigorously at room temperature 27° C. (±5) for 5-6 h or till a homogeneous mixture without lumps is obtained and labelled as solution-B.

Step 5: The solution-A was transferred into solution-B, and the total volume of the mix was 500 mL and the strength of the sodium alginate was maintained between 1.5-2% w/v. The sodium alginate to Fe—Al mixed metal oxyhydroxides w/w ratio was maintained in-between 1:2-1:2.5. The contents were stirred vigorously at 800-1000 rpm until a uniform homogeneous mixture is formed.

Step 6: In a 1 L beaker, 10.7 g of Calcium Chloride was taken in 600 mL distilled water and stirred until completely dissolved. The strength of the gelation medium was chosen between 1.5-2% w/v and is labelled as Solution-C.

Step 7 and Step 8 are same as discussed in Example-1.

### Example-5

This example describes the method of preparing ternary metal oxyhydroxide biopolymer composite bead adsorbent comprising of Fe:Al:La in weight ratios of 1:2.5:0.35 for fluoride removal from water, and the sample is denoted as MBC06.

The sample preparation comprises the following steps:

Step 1: 3.26 g of iron (III) chloride anhydrous and 2.78 g of ferrous sulphate heptahydrate were weighed and put in a 500 mL capacity beaker containing 200 mL distilled water. The salt contents were mixed thoroughly using a laboratory mixer/magnetic stirrer at 200 rpm. To this solution, 4M NaOH solution was added slowly in a drop-wise manner with vigorous stirring to facilitate the co-precipitation until pH reached 9.2-9.5 at room temperature 27° C. (±5). The precipitate was stirred for 30 minutes more, followed by washing with distilled water for 5-6 times to remove unwanted impurities.

Step 2: In another 1 L beaker, the precipitate obtained in Step-1 was dispersed in 500 mL distilled water and to this 49 g of aluminium sulfate hexadecahydrate precursor salt was added under stirring. To this, 1.1 g of Lanthanum nitrate hexahydrate precursor salt was added and continued the stirring for 1 hour and then under a condition of mechanical stirring of 500-700 rpm, 6N potassium hydroxide solution was added dropwise. The pH of the suspension was allowed to rise gradually to 8 at room temperature 27° C. (±5). The precipitates obtained were further stirred for 30 minutes more at that pH and allowed to settle.

Step 3: Same as discussed Example-1. The obtained products were dispersed in 500 mL of distilled water in a 1000 mL beaker and labelled as solution −A.

Step 4: In a 2000 mL capacity beaker, 6.5 g of sodium alginate was weighed and dissolved in 200 mL distilled water and the contents were stirred vigorously at room temperature 27° C. (±5) for 5-6 h or till a homogeneous mixture without lumps is obtained and labelled as solution-B.

Steps 5, 6, 7, and 8 are the same as discussed in Example-2.

### Example-6

In this example, ternary metal oxyhydroxide biopolymer composite bead adsorbent comprising of Fe:Al:Zr in weight ratios of 1:2.5:0.35 was prepared for fluoride removal from water and the sample is denoted as MBC07.

Step 1: Iron oxide nanoparticles were prepared by following the procedures given in Step-1 of Example-5.

Step 2: In another 1 L beaker, the precipitate obtained in Step-1 was dispersed in 500 mL distilled water and to this 49 g of aluminium sulfate hexadecahydrate and 1.095 g of zirconium sulfate hydrate precursor salts were added and continued stirring for 1 hour and then under a condition of mechanical stirring of 500-700 rpm, 6N potassium hydroxide solution was added dropwise. The pH of the suspension was allowed to rise gradually to 8 at room temperature 27° C. (±5). The precipitates obtained were further stirred for 30 minutes more at that pH and allowed to settle.

Step 3: Washing of the precipitate is same as discussed in Example-1. The obtained products were dispersed in 500 mL of distilled water in a 1000 mL beaker and labelled as a solution-A.

Step 4: In a 2000 mL capacity beaker, 6.5 g of sodium alginate was weighed and dissolved in 200 mL distilled water and the contents were stirred vigorously at room temperature 27° C.(±5) for 5-6 h or till a homogeneous mixture without lumps is obtained and labelled as solution-B.

Steps 5, 6, 7, and 8 are the same as discussed in Example-2.

Defluoridation performance of different Metal oxyhydroxide Biopolymer Composite (MBC) bead samples as prepared in Examples 1 to 6 are listed in Table 1. The performance of the prepared granules compared with commercial activated alumina (AA) beads purchased from a local vendor. The activated alumina granules were treated with 2% acid (H₂SO₄/HCl) solution to bring the pH 5.5-6.0 then used for fluoride and arsenic adsorption experiments. Synthetic fluoride spiked water was prepared by dissolving 0.221 g of NaF salt (oven dried at 110° C. for 2 h) in 1000 mL deionized water. Requisite 10 ppm F⁻ water was prepared by making dilutions and pH was adjusted to near 7.2 (±0.1). It is clear from the results (Table 1) that the binary and ternary mixed metal oxyhydroxides containing biopolymer composite beads showed higher removal performance at neutral pH as compared to commercial activated alumina granules under similar experimental conditions.

TABLE 1
Fluoride adsorption performance results of mixed metal oxyhydroxides
beads along with commercial activated alumina granules (Conditions:
Initial fluoride: 9.88 mg/L; Bead dose: 4 g/L; Solution pH:
7.2(±0.1); time -24 h; temperature 29° C.)

| | Metal weight ratios in | Final concentration | Fluoride |
|---|---|---|---|
| | Biopolymer solution | of fluoride in the | percent |
| Sample ID | of 1.5-2 wt % in all | solution, mg/L | removal |
| MBC02 | Fe:Al(1:1) | 3.45 | 65.0 |
| MBC03 | Fe:Al (1:2.5) | 2.80 | 71.7 |
| MBC04 | Fe:Al(1:3) | 2.56 | 74.1 |
| MBC05 | Fe:Al(1:4) | 2.00 | 79.8 |
| MBC06 | Fe:Al:La (1:2:0.3) | 2.14 | 77.4 |
| MBC07 | Fe:Al:Zr (1:2:0.3) | 2.09 | 77.9 |
| Commercial | — | 5.80 | 40.8 |
| Activated | | | |
| alumina | | | |
| granules | | | |

### Example-7

For defluoridation performance of adsorbent MBC03 bead sample as prepared in Example-2 was taken for real-life groundwater treatment in this example. Fluoride-containing groundwater was collected from a fluoride endemic village in Odisha, was analysed for important water parameters by using different instrumental techniques and the results are listed in Table 2. A batch adsorption experiment was conducted at different adsorbent dose variations of 0.5-4.0 g/L of groundwater. The rest of the procedure is similar as described in Example-6. Results are listed in Table 3.

TABLE 2
Analysis of groundwater sample collected
from fluoride endemic region

| Parameter | Characteristic Value |
|---|---|
| pH | 7.46 |
| F⁻, mg/L | 2.96 |
| TDS, mg/L | 415.4 |
| Conductivity, μS/cm | 483.11 |
| Alkalinity, mg/L | 293.5 |
| Total Hardness, mg/L | 139.8 |
| SO₄²⁻, mg/L | 52.83 |
| Cl⁻, mg/L | 14.6 |
| Ca, mg/L | 16.1 |
| Na, mg/L | 47.9 |

TABLE 3
Performance evaluation of adsorbent beads for treatment of fluoride-
containing groundwater collected from fluoride endemic village,
Odisha, India (Conditions: fluoride-2.94 mg/L; pH-7.46; time:
16 h; MBC03 bead dose: 0.5-4.0 g/L; Temperature 29° C.).

| | | | Activated | |
|---|---|---|---|---|
| Adsorbent | MBC03 adsorbent bead | | alumina granules | |
| dose (g/L) | Final, F⁻ mg/L | % Removal | Final F⁻ mg/L | % Removal |
| 0.5 | 2.40 | 17.24 | 2.71 | 6.55 |
| 1.0 | 2.31 | 20.34 | 2.55 | 12.10 |
| 2.0 | 1.64 | 43.45 | 2.36 | 18.62 |
| 3.0 | 1.12 | 61.38 | 2.25 | 22.41 |
| 4.0 | 0.91 | 68.72 | 2.08 | 28.28 |
| 5.0 | 0.62 | 79.0 | 1.80 | 38.8 |
| 6.0 | 0.11 | 96.00 | 1.45 | 50.6 |

### Example-8

The arsenic removal performance of Mixed metal oxyhydroxide Biopolymer Composite (MBC02 to MBC06) bead samples as prepared in Example-1 to 6 are discussed in this Example. Arsenic (III) and Arsenic (V) 100 mg/L stock solutions were prepared by taking 0.1734 g of NaAsO₂ in 1000 mL and 0.416 g Na₂HasO₄ in deionized water. The arsenic concentrations in ppb (parts perbillion) levels were prepared by appropriate dilutions and used in the studies. Arsenic(V) removal performance of the different adsorbent samples is reported in Table 4. The performance of the selected MBC adsorbent at different dose variations for removal of arsenic(III) and arsenic (V) species is reported in Table 5.

TABLE 4
Arsenic (V) adsorption performance studies of different
mixed metal oxyhydroxides beads along with commercial
activated alumina granules (Conditions: Initial Arsenic(V)
conc.,: 81.14 μg/L; adsorbent Bead dose: 3 g/L; Solution
pH: 7.42(±0.1); Time: 24 h; Temperature 29° C.)

| | Final concentration of | |
|---|---|---|
| Sample ID | As(V) in the solution, μg/L | Percent removal |
| MBC02 | 13.62 | 83.2 |
| MBC03 | 6.97 | 92.4 |
| MBC04 | 6.20 | 92.5 |
| MBC05 | 6.94 | 91.4 |
| MBC06 | 6.14 | 92.4 |
| MBC07 | 5.92 | 92.7 |
| Commercial Activated | 12.80 | 84.2 |
| alumina granules | | |

TABLE 5
Arsenite and Arsenate removal performance of MBC03 adsorbent
beads as a function of adsorbent dose variation (Conditions:
Arsenite 492 μg/l, Arsenate: 494 μg/l; Contact Time: 24
h; Temperature: 26° C.; pH-7.13; the volume of the water taken 50 mL)

| MBC | Arsenite Removal | | Arsenate Removal | |
|---|---|---|---|---|
| Dose | Final Arsenite | % Arsenite | Final Arsenate | % Arsenate |
| g/L | Concentration | Removal | Concentration | Removal |
| 2 | 443.21 | 10.28 | 245.80 | 50.84 |
| 4 | 226.60 | 54.13 | 68.55 | 86.29 |
| 6 | 178.25 | 63.91 | 14.08 | 97.18 |
| 8 | 176.78 | 64.21 | nd | 100 |
| 10 | 158.42 | 67.93 | nd | 100 |
| 16 | 112.25 | 77.27 | nd | 100 |
| 24 | 12.87 | 97.39 | nd | 100 |
| 28 | 4.040 | 99.18 | nd | 100 |

*nd—not detectable

### Example-9

Regeneration experiments on fluoride and arsenic loaded Metal oxyhydroxide Biopolymer Composite (MBC03) adsorbent is discussed in this example. The used Mixed metal oxyhydroxides-Biopolymer Composite (MBC) beads loaded with fluoride were subjected to selected eluents. For this study, fluoride-loaded beads were prepared by treating 1 L of 50 mg/L F⁻ containing water with 4 g of the bead at pH 7.1 by batch experiment. The contents were agitated for 24 h at room temperature (27° C.) and the supernatant was analyzed for the remaining fluoride concentration value was found to be 12.5 mg/L with calculated adsorption capacity 9.4 mg/g. The fluoride-loaded MBC beads were used for conducting sequential desorption batch experiments in which the exhausted beads were periodically exposed to eluent mediums in three stages. The conditions such as pH near 2.5-3.0 with acids and pH range of 10-11 with alkali were carefully chosen with acid and alkali respectively. Highly acidic, pH<2.5 and alkaline pH >11 were found to be not suitable as the bead structure gets destructed and chances of dissolution of adsorbent metal ions into the water. Results are shown in Table 6.

TABLE 6
Regeneration performance of Fluoride desorption (Conditions:
Initial fluoride concentration: 37.5 mg/L; MBC03
adsorbent dose: 100 mg/100 mL of eluent, contact
time: 24 h; temperature ambient (28-29° C.).

| | |
|---|---|
| Regeneration media | Percent of desorption |

| | | |
|---|---|---|
| 8-10 | mM CH₃COOH | 35-62% |
| 1.5-3 | mM HCl | 17-62% |
| 0.2-0.5 | mM NaOH | 32-75.5% |

For regeneration studies on arsenic loaded MBC beads, batch adsorption experiment was conducted by taking 50 mL of 1000 μg/L arsenic solution containing As(III)500 μg/L+As(V)500 μg/L with 250 mg of MBC03 beads, the contact time was 24 h, pH adjusted at 7.15(±0.1) at a temperature of 29° C. The analysis of the supernatant solution showed a total arsenic concentration of 253.73 μg/L. The beads were washed, dried, and used for desorption experimental conditions as mentioned for fluoride. The results are presented in Table 7.

TABLE 7
Adsorption and desorption and regeneration performance
of used MBC beads Conditions: Dose; 250 mg/100 ml
of eluent, Shaking Time: 24 h; Temp: 27° C.

| | |
|---|---|
| Regeneration Media | % Desorption |

| | | |
|---|---|---|
| 0.2-0.5 | mM NaOH | 30-67 |
| 8-10 | mM CH₃COOH | 45-80 |

### Example-10

Column adsorption performance of adsorbent as prepared in Example-2 was taken for continuous mode defluoridation of water. In a 30 cm Perspex column, with 1 cm inner diameter was packed with MBC03 beads. The void volume of the beads packed column was approximately 7 mL. The column was run in an up-flow mode using a peristaltic pump with a flow rate of 1.2 mL/min and an influent F⁻ concentration of 2.9 mg/L, at a pH of 7.32. The calculated residence time of the column was 0.317 h; samples were collected periodically and analyzed for the residual F⁻ concentrations. About, 16.1 g of commercially purchased activated alumina granules were packed in the same size column and continuous column runs were performed for defluoridation. All the other column parameters were maintained under similar conditions. The breakthrough concentration was fixed at 1.5 mg/L. The defluoridation capacities of the MBC beads and purchased activated alumina granules at different time intervals are presented in Tables 8 and 9 for MBC and AA, respectively.

TABLE 8
Defluoridation performance evaluation of MBC and Activated alumina
granules with groundwater (Conditions: Feed water F⁻ conc.,
2.9; Feed water pH: 7.4; Flow rate: 72 mL/h; Bed height: 30 cm)

| | | Column with MBC | | Column with Activated | |
|---|---|---|---|---|---|
| | | adsorbent, 12.9 g | | alumina granules, 16.1 g | |
| | Sampling | F−, mg/L | Percent | F−, mg/L | Percent |
| Sl. No | time (h) | Concn. | removal | Concn | removal |
| 1 | 1 | 0.04 | 98.57 | 0.16 | 94.6 |
| 2 | 24 | 0.08 | 97.27 | 0.40 | 86.6 |
| 3 | 48 | 0.15 | 95.00 | 0.85 | 71.4 |
| 4 | 72 | 0.21 | 93.10 | 1.20 | 60.0 |
| 5 | 96 | 0.37 | 87.80 | 1.38 | 53.3 |
| 6 | 120 | 0.52 | 82.60 | 1.55 | 47.6 |
| 7 | 144 | 0.82 | 72.73 | 1.71 | 40.2 |
| 8 | 168 | 0.97 | 67.67 | | |
| 9 | 192 | 1.19 | 60.34 | | |
| 10 | 216 | 1.26 | 57.99 | | |
| 11 | 240 | 1.34 | 54.67 | | |
| 12 | 264 | 1.44 | 53.72 | | |
| 13 | 288 | 1.48 | 51.99 | | |
| 14 | 312 | 1.56 | 50.67 | | |
| 15 | 336 | 1.72 | 47.99 | | |

TABLE 9
Comparison of real-life groundwater defluoridation performance
of MBC beads and Commercial activated alumina granules.

| | Volume of the | |
|---|---|---|
| | water treated at | Breakthrough Loading |
| Adsorbent | breakthrough, L | capacity, mg/g |
| MBC Beads | 20.74 | 4.66 |
| Commercial activated | 7.92 | 1.43 |
| alumina beads | | |

### Example-11

After 3-4 cycles of reuse, the fluoride removal performance of the adsorbent beads dropped, indicating that the exhausted media need to be disposed off safely. This example explains the Toxicity Characteristic Leaching Procedure (TCLP) test on fluoride saturated MBC03 beads and determines the extent of leaching/mobility of the adsorbed fluoride ions present in the beads to the environment when disposed of as solid waste. For this experiment, standard operating procedure (SOP-8131) based on Environmental Protection Agency (EPA) SW-846 Test Method 1311 was followed. The experiment was carried out by following two steps:

Step-1: About 5 g of used MBC beads were crushed to <1 mm and was taken in a 500 mL beaker along with 96.5 mL of reagent water and covered with a watch glass. The contents were kept for vigorous stirring for 5 minutes using a magnetic stirrer. The pH of this solution was recorded as 5.46, further 3.5 mL of 1N HCl was added, stirred, and covered with a watch glass, and heated at 50° C. for 10 minutes. The solution showed pH<5.0, therefore extraction Fluid #1 was selected for the second step. The required extraction Fluid #1 was prepared by taking 5.7 mL of glacial CH₃CH₂OOH to 500 mL of reagent water. To this, 64.3 ml of 1N NaOH was added, and diluted to a volume of 1 L, the pH of this fluid was adjusted to 4.93±0.05.

Step-2: The requisite volume of extraction Fluid #1 was taken in a Polypropylene bottle along with the bead material for extraction. The Teflon tape was on the threads of the bottle to close tightly. The extraction bottle was kept for 18 h under agitation at 30 rpm, at a temperature of 25° C. After the extraction period, the solids were separated by a glass fiber filter and the final fluoride concentration in the liquid was analyzed. The TCLP test was triplicated and reported. The fluoride concentrations in the extracted liquid were found to be in the range of 0.5-3 mg/L. The observed values are well within the permissible limit (50 mg/L) as per Central Pollution Control Board, India and United States, Environmental Protection Agency guidelines.

### Advantages of the Invention

A distinct advantage of the metal oxyhydroxide biopolymer composite adsorbent for fluoride removal from water is that they are hydraulically conductive and easily separable, no requirement of external energy/force/devices for the solid-liquid separation. Additional aspects of the present invention is simple method of preparation, and do not require elevation of temperature or pressure.

Another advantage is that unwanted sludge formation can be avoided.

The dry beads stored at room temperatures showed no alteration after 24 months.

Developed adsorbent bead showed higher removal efficiency for fluoride groundwater at pH of 7-7.3.

Working pH range is 4.5-8.0 for de-fluoridation of water using MBC adsorbent beads.

In the pH range of 4.5-8.0, there is no release of adsorbent metal ions into the treated water.

The pH of the treated water is well within the acceptable range of drinking water.

The MBC beads are easy to transport and store when required.

The MBC beads are stable and do not swell or revert back to gel state in the aqueous medium.

The MBC beads can be used either in batch purification or in continuous flow purification system.

The used beads can be regenerated for 3-4 cycles under controlled pH conditions

The exhausted MBC beads safe for land fill disposal.

1. A mixed metal oxyhydroxide biopolymer composite beads for fluoride removal from drinking water wherein, the said beads comprising:
(a) 15 to 55 (w/w) % of a metal content;
(b) 10 to 35 (w/w) % of a biopolymer;
remaining being oxygen and hydrogen.

2. The mixed metal oxyhydroxide biopolymer composite beads as claimed in claim 1, wherein the metal is in the form of binary or ternary mixed metal oxide hydroxide nanoparticles.

3. The mixed metal oxyhydroxide biopolymer composite beads as claimed in claim 1, wherein the metal is selected from the group consisting of Fe, Al, Cu, Mn, La, Zr, Ce and Mg.

4. The mixed metal oxyhydroxide biopolymer composite beads as claimed in claim 1, wherein the mixed metal content comprises Fe and Al in the range of 6:1 to 1:6.

5. The mixed metal oxyhydroxide biopolymer composite beads as claimed in claim 1, wherein the mixed metal content comprises Fe:Al:Z in the range of 1:1 to 6:0.1 to 0.7, wherein Z is a metal selected from the group consisting of Cu, Mn, La, Zr, Ce and Mg.

6. The mixed metal oxyhydroxide biopolymer composite beads as claimed in claim 1, wherein the biopolymer is sodium alginate.

7. The mixed metal oxyhydroxide biopolymer composite beads as claimed in claim 1, wherein the beads exhibit the characteristic properties—Surface areas: 40 to 100 m²/g; Pore Volume: 0.25 to 0.45 cm³/g; and Pore size: 100 to 180 Å.

8. The mixed metal oxyhydroxide biopolymer composite beads as claimed in claim 1, wherein the beads exhibit fluoride and arsenic removal efficiencies to the extent of >90% from contaminated groundwater at pH range of 5 to 8, and at temperature ranging from 10 to 35 degrees.

9. The mixed metal oxyhydroxide biopolymer composite beads as claimed in claim 1, wherein the beads show fluoride adsorption capacities of 5 to 20 mg/g and arsenic adsorption capacities of 500 to 1000 μg/g, and 100 to 200 μg/g for arsenate and arsenite, respectively.

10. A process for the preparation of mixed metal oxyhydroxide biopolymer composite beads as claimed in claim 1, wherein the steps comprise:
(i) preparing mixed metal oxyhydroxide nanoparticles by co-precipitation and/or deposition precipitation method by taking iron and aluminium (binary system) or iron and aluminium along with any one or combinations of elements selected from the group comprising of lanthanum/zirconium/cerium/copper/manganese/magnesium (ternary system) inorganic precursor salt solutions at temperature ranging from 10 to 40 degree at pH of 6 to 10 using NaOH and/or KOH as precipitating base;
(ii) washing the mixed metal oxyhydroxide nanoparticles as obtained in step (i) to remove unwanted impurities;
(iii) simultaneously preparing the biopolymer solution by dissolving 0.5 to 5.0% w/v sodium alginate solution in distilled water under vigorous stirring;
(iv) dispersing the washed mixed metal oxide hydroxide nanoparticles as obtained in step (ii) in aqueous medium at concentration ranging from 4.0 to 6.0% w/v and contacting with the biopolymer solution as obtained in step (iii) maintaining the biopolymer to mixed metal oxide hydroxide in a weight ratios ranging from 1:1 to 1:3 to obtain homogeneous mixture of mixed metal oxyhydroxide biopolymer composite;
(v) contacting the mixed metal oxyhydroxide biopolymer composite as obtained in step (iv) with a chelating agent by dropwise addition to obtain spherical gel beads followed by curing of the beads in the same bath for a period of 4 to 48 hours;
(vi) washing the beads obtained in step (v) with water repeatedly followed by protonation by soaking them in acidified water for a period of 4 to 48 hours;
(vii) washing the protonated beads as obtained in step (vi) thoroughly until the pH of the wash water is in the range of 5 to 6 followed by drying the beads at a temperature in the range of 60 to 65 degree until complete drying to obtain the desired mixed metal oxyhydroxide biopolymer composite beads.

11. The process as claimed in claim 10, wherein the concentration of inorganic precursor salt solutions are in the range of 0.1 to 1.0 molar solutions for iron and aluminium; 0.05 to 0.1 molar solutions of Ce/La/Zr/Cu/Mn/Mg; and 2-6 molar solutions of alkali NaOH/KOH/NH₃.

12. The process as claimed in claim 10, wherein the chelating agent is selected from 1 to 5% w/v CaCl₂).

13. A process for the removal of arsenic and fluoride from water using the mixed metal oxyhydroxide biopolymer composite beads as claimed in claim 1, wherein the steps comprise:
(a) contacting fluoride/arsenic ions containing water with mixed metal oxide hydroxide biopolymer composite beads, in the pH range of 5-8, at a temperature of 20-35° C.; at an agitation speed of 140-160 rpm; for a period of 1-24 hrs to obtain fluoride/arsenic ions depleted water;
(b) contacting fluoride ions containing groundwater with mixed metal oxide hydroxide biopolymer beads loaded fixed bed column/reactor in up-flow mode with required residence time to get fluoride ions free water;
(c) contacting the fluoride and arsenic ions containing exhausted mixed metal oxide hydroxide biopolymer composite beads with sodium hydroxide solution at pH 10-11 for 78 hrs for desorption followed by activation with hydrochloric acid/acetic acid; at a pH 2.5-3.5; for a 24 h in 2-3 batches to get regenerated beads.
